(19) United States
(12) Patent Application Publication
(10) Pub. No.: US 2019/0185492 A1
(43) Pub. Date: Jun. 20, 2019

(54) Ionic Covalent Organic Frameworks with Tetra-Coordinated Borate Linkages

(71) Applicants: Shun Wan, Timnath, CO (US); Wei Zhang, Boulder, CO (US)

(72) Inventors: Shun Wan, Timnath, CO (US); Wei Zhang, Boulder, CO (US)

(21) Appl. No.: 15/848,037

(22) Filed: Dec. 20, 2017

(51) Int. Cl. C07F 5/02; H01M 10/0565

(52) U.S. Cl. CPC C07F 5/022; H01M 2300/0082; H01M 10/0565

(57) ABSTRACT

The invention provides novel ionic covalent organic frameworks comprising stable tetra-coordinated borate linkages. The invention further provides methods of making novel ionic covalent organic frameworks comprising tetra-coordinated borate linkages. The invention also provides compositions comprising novel ionic covalent organic frameworks.

### STATEMENT REGARDING FEDERALLY SPONSORED RESEARCH OR DEVELOPMENT

This invention was made with government support under grant number DMR1055705 awarded by the National Science Foundation. The government has certain rights in the invention.

### BACKGROUND OF THE INVENTION

Covalent organic frameworks (COFs) represent a novel class of porous crystalline organic materials with rigid structures, high thermal stabilities, and low densities. The two or three-dimensional architectures of COFs have permanent open channels and accessible voids created by the covalently linked rigid building blocks. COFs have been used to promote gas adsorption/separation and catalysis, as well as in electronic devices. However, their practical applications have been impeded by the instability of the COFs, particularly in the case of boroxine or boronate ester-containing frameworks.

There remains a need in the art for COFs that are stable to working conditions and exhibit useful properties. In certain embodiments, the COFs should exhibit resistance towards hydrolysis and be stable in a range of solvents including water and alcohols, particularly under basic conditions. The present invention addresses these needs.

### BRIEF DESCRIPTION OF THE DRAWINGS

The following detailed description of specific embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1 is a scheme depicting a model transesterification reaction between diol 1 and trimethyl borate to form a tetra-coordinated borate linkage in product 2.

FIGS. 2A-2B are schemes depicting synthesis of a tetra-coordinated borate linked ionic covalent organic framework (ICOF) of the invention.

FIG. 3 is a graph reporting results of thermal gravimetric analysis of the Me₂NH₂⁺ (ICOF-1) and Li⁺ (ICOF-2) ICOFs of the invention.

FIG. 4A is a powdered X-ray diffraction pattern of ICOF-2.

FIGS. 4B-4C are proposed structural representations of ICOF-2 in a top view (FIG. 4B) and a side view (FIG. 4C).

FIGS. 5A-5B depict PXRD patterns of ICOF-1 and ICOF-2 after water, acid and base treatments. FIG. 5A depicts the patterns for ICOF-1 and FIG. 5B depicts the patterns for ICOF-2.

FIGS. 5C-5G are SEM images of ICOF-1 and ICOF-2 under varied conditions. FIGS. 5C-5D are SEM images of ICOF-1 as synthesized (FIG. 5C) and after water treatment (FIG. 5D). FIGS. 5E-5G are SEM images of ICOF-2 as synthesized (FIG. 5E), after water treatment (5F) and after 1 M LiOH treatment (FIG. 5G).

FIGS. 6A-6B are graphs reporting nitrogen gas adsorption isotherms for ICOF-1 (6A) and both ICOF-1 and ICOF-2 (6B) measured at 77 K. Filled symbols represent adsorption and hollow symbols represent desorption.

FIG. 6C is a graph reporting hydrogen and methane adsorption isotherms for ICOFs of the invention.

FIG. 6D is a graph reporting pore size distribution profiles for ICOF-1 and ICOF-2.

FIGS. 7A-7D are graphs reporting electrochemical tests performed on a film comprising ICOF-2 microcrystals and polyvinylidene fluoride (PVDF) in N-methyl-2-pyrrolidone (NMP). FIG. 7A reports a Nyquist plot of AC impedance sweeps at various temperatures. FIG. 7B reports ionic conductivity as a function of temperature. FIG. 7C reports lithium transference number as calculated using Bruce-Vincent-Evans technique. FIG. 7D reports cathodic and anodic linear sweep voltammetry of the ICOF-2.

### DETAILED DESCRIPTION OF THE INVENTION

The invention provides ionic covalent organic frameworks comprising stable tetra-coordinated borate linkages. The invention further provides methods of making ionic covalent organic frameworks comprising tetra-coordinated borate linkages. The invention also provides compositions comprising novel ionic covalent organic frameworks.

Tetra-coordinated borates are ionic derivatives of boronic acid comprising a negatively charged boron substituted with four alkoxy groups that exhibit high resistance toward hydrolysis and are stable in water, methanol, and under basic conditions. As demonstrated herein, COFs linked by tetra-coordinated borates have the potential to function as ion conductive materials. The tetra-coordinated borate linkage can be formed readily through the condensation of polyols with alkali tetraborate or boric acid, and/or through the transesterification between borate and polyols in a thermodynamic manner. The present invention makes use of these properties of tetra-coordinated borate linkages and applies them to COFs.

### Definitions

Unless defined otherwise, all technical and scientific terms used herein have the same meaning as commonly understood by one of ordinary skill in the art of organic synthesis and material science. Although any methods and materials similar or equivalent to those described herein can be used in the practice or testing of the present invention, exemplary methods and materials are described. As used herein, each of the following terms has the meaning associated with it in this section. The instant invention is understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the term “alkyl,” by itself or as part of another substituent means, unless otherwise stated, a straight or branched chain hydrocarbon having the number of carbon atoms designated (i.e. C₁₋₆ means one to six carbon atoms) and including straight, branched chain, or cyclic substituent groups. Examples include methyl, ethyl, propyl, isopropyl, butyl, isobutyl, tert-butyl, pentyl, neopentyl, hexyl, and cyclopropylmethyl. Most preferred is (C₁-C₆)alkyl, particularly ethyl, methyl, isopropyl, isobutyl, n-pentyl, n-hexyl and cyclopropylmethyl.

As used herein, the term “substituted alkyl” means alkyl as defined above, substituted by one, two or three substituents selected from the group consisting of halogen, —OH, alkoxy, —NH₂, —N(CH₃)₂, —C(═O)OH, trifluoromethyl, —C≡N, —C(═O)O(C₁-C₄)alkyl, —C(═O)NH₂, —SO₂NH₂, —C(═NH)NH₂, and —NO₂, preferably containing one or two substituents selected from halogen, —OH, alkoxy, —NH₂, trifluoromethyl, —N(CH₃)₂, and —C(═O)OH, more preferably selected from halogen, alkoxy and —OH. Examples of substituted alkyls include, but are not limited to, 2,2-difluoropropyl, 2-carboxycyclopentyl and 3-chloropropyl.

As used herein, the term “haloalkyl” means alkyl as defined above, substituted by one, two or three substituents selected from the group consisting of F, Cl, Br, and I.

As used herein, the term “heteroalkyl” by itself or in combination with another term means, unless otherwise stated, a stable straight or branched chain alkyl group consisting of the stated number of carbon atoms and one or two heteroatoms selected from the group consisting of O, N, and S, and wherein the nitrogen and sulfur atoms may be optionally oxidized and the nitrogen heteroatom may be optionally quaternized or substituted. The heteroatom(s) may be placed at any position of the heteroalkyl group, including between the rest of the heteroalkyl group and the fragment to which it is attached, as well as attached to the most distal carbon atom in the heteroalkyl group. Examples

include: —O—CH₂—CH₂—CH₃, —CH₂—CH₂—CH₂—OH, —CH₂—CH₂—NH—CH₃, —CH₂—S—CH₂—CH₃, —NH—(CH₂)ₘ—OH (m=1-6), —N(CH₃)—(CH₂)ₘ—OH (m=1-6), —NH—(CH₂)ₘ—OCH₃ (m=1-6), and —CH₂CH₂—S(═O)—CH₃. Up to two heteroatoms may be consecutive, such as, for example, —CH₂—NH—OCH₃, or —CH₂—CH₂—S—S—CH₃

As used herein, the term “alkoxy” employed alone or in combination with other terms means, unless otherwise stated, an alkyl group having the designated number of carbon atoms, as defined above, connected to the rest of the molecule via an oxygen atom, such as, for example, methoxy, ethoxy, 1-propoxy, 2-propoxy (isopropoxy) and the higher homologs and isomers. Preferred are (C₁-C₃) alkoxy, particularly ethoxy and methoxy.

As used herein, the term “halo” or “halogen” alone or as part of another substituent means, unless otherwise stated, a fluorine, chlorine, bromine, or iodine atom, preferably, fluorine, chlorine, or bromine, more preferably, fluorine or chlorine.

As used herein, the term “cycloalkyl” refers to a mono cyclic or polycyclic non-aromatic radical, wherein each of the atoms forming the ring (i.e. skeletal atoms) is a carbon atom. In certain embodiments, the cycloalkyl group is saturated or partially unsaturated. In other embodiments, the cycloalkyl group is fused with an aromatic ring. Cycloalkyl groups include groups having from 3 to 10 ring atoms. Illustrative examples of cycloalkyl groups include, but are not limited to, the following moieties:

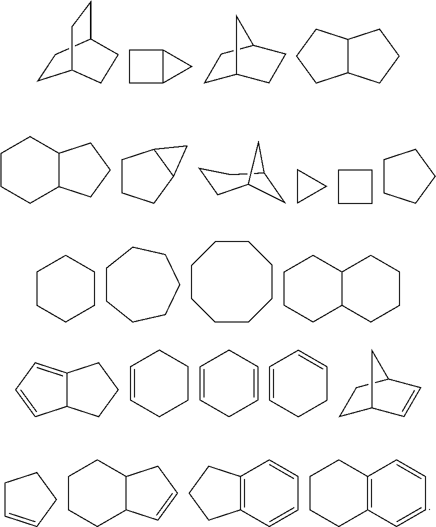

Monocyclic cycloalkyls include, but are not limited to, cyclopropyl, cyclobutyl, cyclopentyl, cyclohexyl, cycloheptyl, and cyclooctyl. Dicyclic cycloalkyls include, but are not limited to, tetrahydronaphthyl, indanyl, and tetrahydropentalene. Polycyclic cycloalkyls include adamantine and norbornane. The term cycloalkyl includes “unsaturated nonaromatic carbocyclyl” or “nonaromatic unsaturated carbocyclyl” groups, both of which refer to a nonaromatic carbocycle as defined herein, which contains at least one carbon carbon double bond or one carbon carbon triple bond.

As used herein, the term “heterocycloalkyl” or “heterocyclyl” refers to a heteroalicyclic group containing one to four ring heteroatoms each selected from O, S and N. In certain embodiments, each heterocycloalkyl group has from 4 to 10 atoms in its ring system, with the proviso that the ring of said group does not contain two adjacent O or S atoms. In other embodiments, the heterocycloalkyl group is fused with an aromatic ring. In certain embodiments, the nitrogen and sulfur heteroatoms may be optionally oxidized, and the nitrogen atom may be optionally quaternized. The heterocyclic system may be attached, unless otherwise stated, at any heteroatom or carbon atom that affords a stable structure. A heterocycle may be aromatic or non-aromatic in nature. In certain embodiments, the heterocycle is a heteroaryl.

An example of a 3-membered heterocycloalkyl group includes, and is not limited to, aziridine. Examples of 4-membered heterocycloalkyl groups include, and are not limited to, azetidine and a beta lactam. Examples of 5-membered heterocycloalkyl groups include, and are not limited to, pyrrolidine, oxazolidine and thiazolidinedione. Examples of 6-membered heterocycloalkyl groups include, and are not limited to, piperidine, morpholine and piperazine. Other non-limiting examples of heterocycloalkyl groups are:

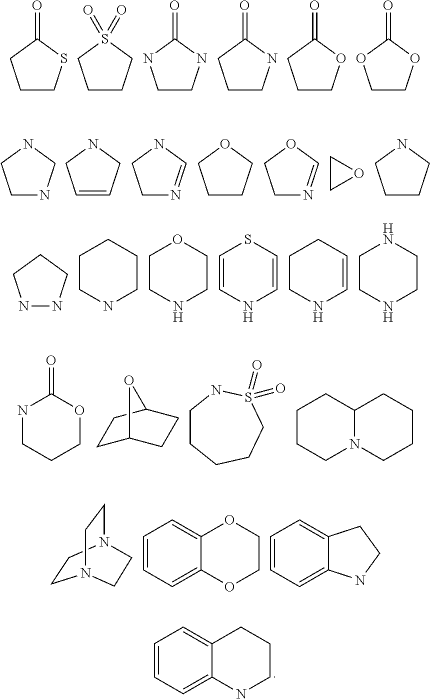

Examples of non-aromatic heterocycles include monocyclic groups such as aziridine, oxirane, thiirane, azetidine, oxetane, thietane, pyrrolidine, pyrroline, pyrazolidine, imidazoline, dioxolane, sulfolane, 2,3-dihydrofuran, 2,5-dihydrofuran, tetrahydrofuran, thiophane, piperidine, 1,2,3,6-tetrahydropyridine, 1,4-dihydropyridine, piperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin, and hexamethyleneoxide.

As used herein, the term “aromatic” refers to a carbocycle or heterocycle with one or more polyunsaturated rings and having aromatic character, i.e. having (4n+2) delocalized 7 (pi) electrons, where n is an integer.

As used herein, the term “aryl,” employed alone or in combination with other terms, means, unless otherwise stated, a carbocyclic aromatic system containing one or more rings (typically one, two or three rings), wherein such rings may be attached together in a pendent manner, such as a biphenyl, or may be fused, such as naphthalene. Examples of aryl groups include phenyl, anthracyl, and naphthyl. Preferred examples are phenyl and naphthyl, most preferred is phenyl.

As used herein, the term “aryl-(C₁-C₃)alkyl” means a functional group wherein a one- to three-carbon alkylene chain is attached to an aryl group, e.g., —CH₂CH₂-phenyl. Preferred is aryl-CH₂— and aryl-CH(CH₃)—. The term “substituted aryl-(C₁-C₃)alkyl” means an aryl-(C₁-C₃)alkyl functional group in which the aryl group is substituted. Preferred is substituted aryl(CH₂)—. Similarly, the term “heteroaryl-(C₁-C₃)alkyl” means a functional group wherein a one to three carbon alkylene chain is attached to a heteroaryl group, e.g., —CH₂CH₂-pyridyl. Preferred is heteroaryl-(CH₂)—. The term “substituted heteroaryl-(C₁-C₃)alkyl” means a heteroaryl-(C₁-C₃)alkyl functional group in which the heteroaryl group is substituted. Preferred is substituted heteroaryl-(CH₂)—.

As used herein, the term “heteroaryl” or “heteroaromatic” refers to a heterocycle having aromatic character. A polycyclic heteroaryl may include one or more rings that are partially saturated. Examples include the following moieties:

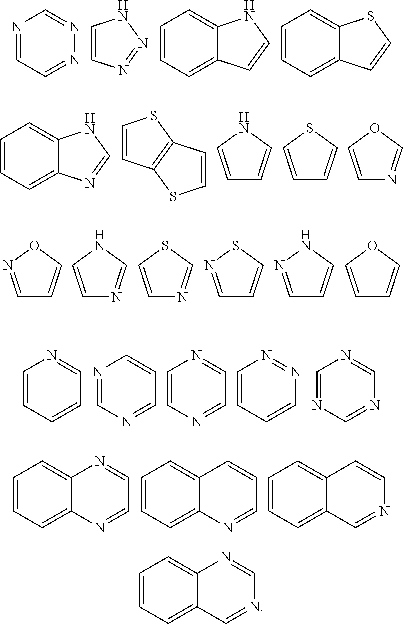

Examples of heteroaryl groups also include pyridyl, pyrazinyl, pyrimidinyl (particularly 2- and 4-pyrimidinyl), pyridazinyl, thienyl, furyl, pyrrolyl (particularly 2-pyrrolyl), imidazolyl, thiazolyl, oxazolyl, pyrazolyl (particularly 3- and 5-pyrazolyl), isothiazolyl, 1,2,3-triazolyl, 1,2,4-triazolyl, 1,3,4-triazolyl, tetrazolyl, 1,2,3-thiadiazolyl, 1,2,3-oxadiazolyl, 1,3,4-thiadiazolyl and 1,3,4-oxadiazolyl.

Examples of polycyclic heterocycles and heteroaryls include indolyl (particularly 3-, 4-, 5-, 6- and 7-indolyl), indolinyl, quinolyl, tetrahydroquinolyl, isoquinolyl (particularly 1- and 5-isoquinolyl), 1,2,3,4-tetrahydroisoquinolyl, cinnolinyl, quinoxalinyl (particularly 2- and 5-quinoxalinyl), quinazolinyl, phthalazinyl, 1,8-naphthyridinyl, 1,4-benzodioxanyl, coumarin, dihydrocoumarin, 1,5-naphthyridinyl, benzofuryl (particularly 3-, 4-, 5-, 6- and 7-benzofuryl), 2,3-dihydrobenzofuryl, 1,2-benzisoxazolyl, benzothienyl (particularly 3-, 4-, 5-, 6-, and 7-benzothienyl), benzoxazolyl, benzothiazolyl (particularly 2-benzothiazolyl and 5-benzothiazolyl), purinyl, benzimidazolyl (particularly 2-benzimidazolyl), benzotriazolyl, thioxanthinyl, carbazolyl, carbolinyl, acridinyl, pyrrolizidinyl, and quinolizidinyl.

As used herein, the term “substituted” means that an atom or group of atoms has replaced hydrogen as the substituent attached to another group. The term “substituted” further refers to any level of substitution, namely mono-, di-, tri-, tetra-, or penta-substitution, where such substitution is permitted. The substituents are independently selected, and substitution may be at any chemically accessible position. In certain embodiments, the substituents vary in number between one and four. In other embodiments, the substituents vary in number between one and three. In yet other embodiments, the substituents vary in number between one and two.

As used herein, the term “optionally substituted” means that the referenced group may be substituted or unsubstituted. In certain embodiments, the referenced group is optionally substituted with zero substituents, i.e., the referenced group is unsubstituted. In other embodiments, the referenced group is optionally substituted with one or more additional group(s) individually and independently selected from groups described herein.

In certain embodiments, the substituents are independently selected from the group consisting of oxo, halogen, —CN, —NH₂, —OH, —NH(CH₃), —N(CH₃)₂, alkyl (including straight chain, branched and/or unsaturated alkyl), substituted or unsubstituted cycloalkyl, substituted or unsubstituted heterocycloalkyl, fluoro alkyl, substituted or unsubstituted heteroalkyl, substituted or unsubstituted alkoxy, fluoroalkoxy, —S-alkyl, S(═O)₂alkyl, —C(═O)NH[substituted or unsubstituted alkyl, or substituted or unsubstituted phenyl], —C(═O)N[H or alkyl]2, —OC(═O)N[substituted or unsubstituted alkyl]2, —NHC(═O)NH[substituted or unsubstituted alkyl, or substituted or unsubstituted phenyl], —NHC(═O)alkyl, —N[substituted or unsubstituted alkyl]C(═O)[substituted or unsubstituted alkyl], —NHC(═O)[substituted or unsubstituted alkyl], —C(OH)[substituted or unsubstituted alkyl]2, and —C(NH₂)[substituted or unsubstituted alkyl]2. In other embodiments, by way of example, an optional substituent is selected from oxo, fluorine, chlorine, bromine, iodine, —CN, —NH₂, —OH, —NH(CH₃), —N(CH₃)₂, —CH₃, —CH₂CH₃, —CH(CH₃)₂, —CF₃, —CH₂CF₃, —OCH₃, —OCH₂CH₃, —OCH(CH₃)₂, —OCF₃, —OCH₂CF₃, —S(═O)₂—CH₃, —C(═O)NH₂, —C(═O)—NHCH₃, —NHC(═O)NHCH₃, —C(═O)CH₃, and —C(═O)OH. In yet one embodiment, the substituents are independently selected from the group consisting of C₁₋₆ alkyl, —OH, C₁₋₆ alkoxy, halo, amino, acetamido, oxo and nitro. In yet other embodiments, the substituents are independently selected from the group consisting of C₁₋₆ alkyl, C₁₋₆ alkoxy, halo, acetamido, and nitro. As used herein, where a substituent is an alkyl or alkoxy group, the carbon chain may be branched, straight or cyclic, with straight being preferred.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

The following abbreviations are used herein:

BET Brunauer-Emmett-Teller

COF covalent organic framework

DMF dimethylformamide

ICOF ionic covalent organic framework

LSV linear sweep voltammetry

MAS magic-angle spinning

NLDFT non-local density functional theory

NMP N-methyl-2-pyrrolidone

NMR nuclear magnetic resonance

PC propylene carbonate

PVDF polyvinylidene fluoride

PXRD powder X-ray diffraction

SEM scanning electron microscopy

TGA thermogravimetric analysis

THF tetrahydrofuran

### Compounds and Compositions

The invention provides novel ionic covalent organic frameworks (ICOFs) comprising tetra-coordinated borate linkages, and compositions comprising the same.

In certain embodiments, the ICOFs comprise one or more building blocks of formula (I):

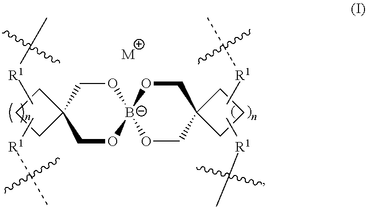

(I), wherein in (I):

n is a number selected from the group consisting of 2 and 3;

each occurrence of R¹ is independently selected from the group consisting of fused C₃-C₁₀ cycloalkylene, fused C₃-C₁₀ heterocyclylene, fused arylene and fused heteroarylene,
wherein the fused C₃-C₁₀ cycloalkylene, fused C₃-C₁₀ heterocyclylene, fused arylene or fused heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl);

M⁺ is a cation selected from the group consisting of Li⁺, Na⁺, K⁺, Cs⁺, Mg²⁺, Ca²⁺, Sr²⁺, Ba²⁺, Al³⁺, Fe²⁺, Fe³⁺, Cr²⁺, Cr³⁺, Mn^{2+,} Mn³⁺, Co²⁺, Co³⁺, Ni^{2+,} Ni³⁺, Cu²⁺, Cu⁺, Au⁺, Au³⁺, Zn²⁺ Ag⁺, Cd²⁺, Cd³⁺, NH₄₊, R²NH₃⁺, (R²)₂NH₂⁺, (R²)₃NH⁺ and (R²)₄N⁺,
wherein each occurrence of R² is independently selected from the group consisting of C₁-C₁₂ alkyl, C₁-C₆ haloalkyl, C₁-C₆ heteroalkyl, aryl, heteroaryl, C₁-C₆ cycloalkyl and C₁-C₆ heterocyclyl; and

each occurrence of R¹ is covalently bound to a linker L through a single bond depicted as [symbol] , wherein each occurrence of L is independently selected from the group consisting of C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene;
wherein the C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl).

In certain embodiments, each occurrence of L is further covalently bound to a R¹ group from a second building block of formula (I), thus covalently connecting the building block to the second building block and forming the structure:

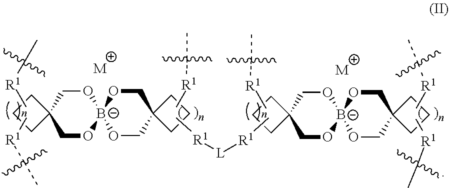

In certain embodiments, L is —C≡C—.

In certain embodiments, the building block of formula (I) is the building block of formula (Ia)

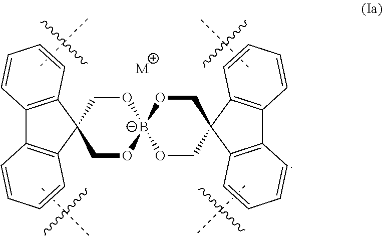

In certain embodiments, the building block of formula (I) is the building block of formula (Ib):

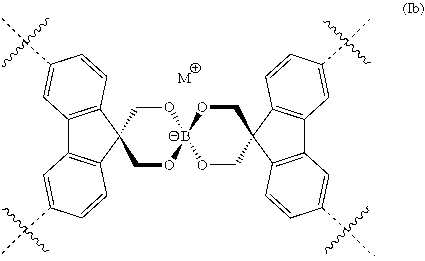

In certain embodiments, each occurrence of L (which is —C≡C—) is further covalently bound to a R¹ group from a distinct building block of formula (I), thus covalently connecting the building block to the distinct building block and forming the structure:

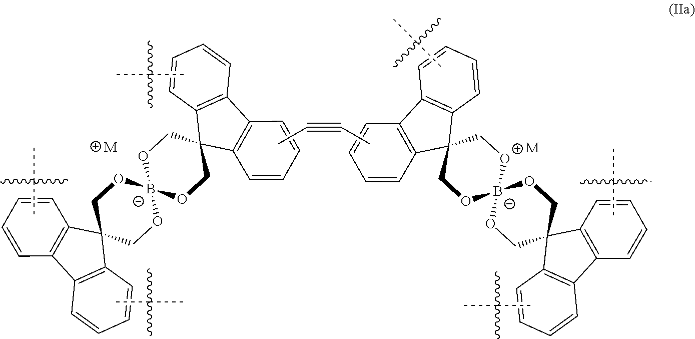

In certain embodiments, each occurrence of L (which is —C≡C—) is further covalently bound to a R¹ group from a distinct building block of formula (I), thus covalently connecting the building block to the distinct building block and forming the structure:

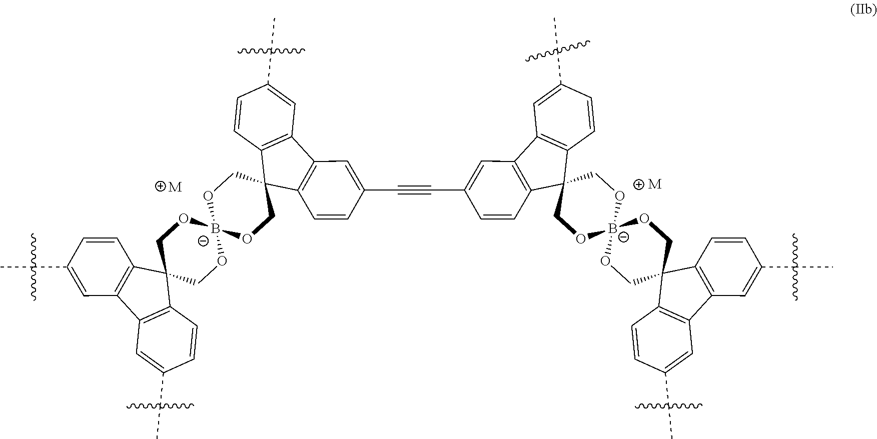

In certain embodiments, M⁺ is a cation selected from the group consisting of Li⁺ and Me₂NH₂⁺.

In certain embodiments, the building blocks of formula (I) form frameworks comprising repeating units of formula:

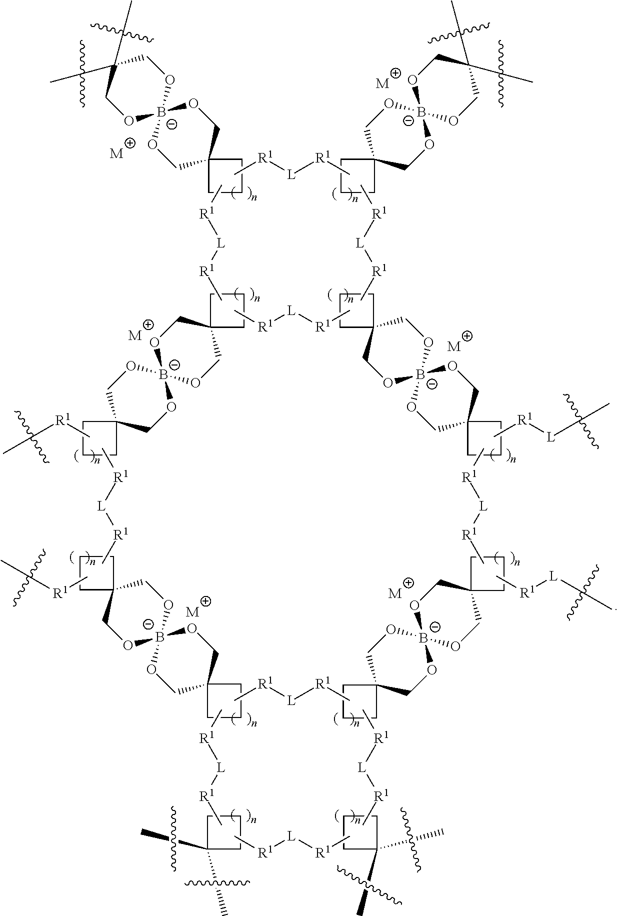

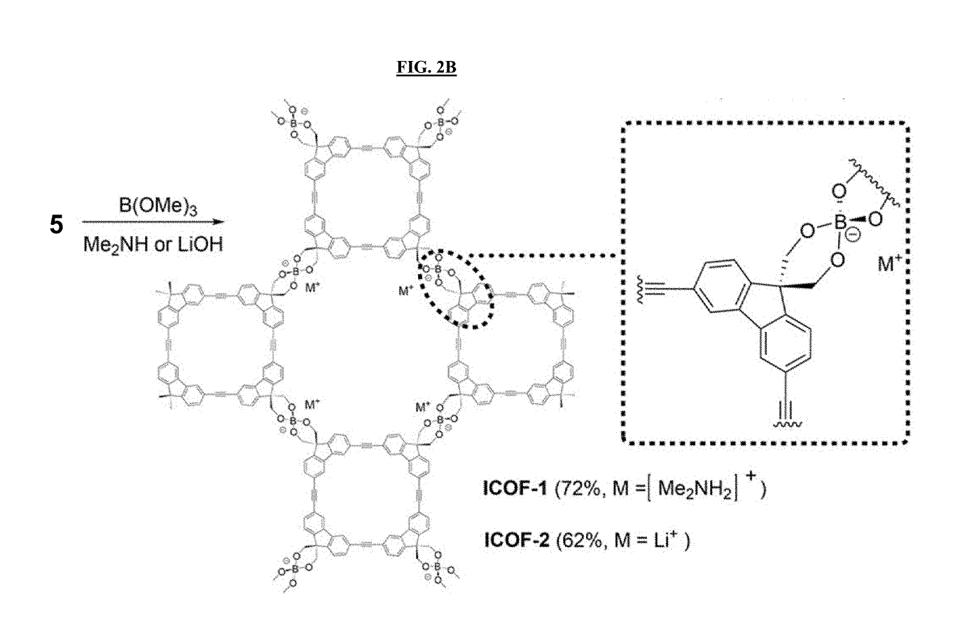

In other embodiments, compounds of formula (Ia) or (Ib) form rigid, repeating frameworks like the one depicted in FIG. 2B.

In certain embodiments, compounds of formulas (I), (Ia), (Ib), (II), (IIa) and/or (IIb) form ICOFs with non-collapsible internal cavities. In other embodiments, the non-collapsible internal cavities impart the bulk ICOF material with micropores. In yet other embodiments, the non-collapsible internal cavities impart the bulk ICOF material with mesopores. In other embodiments, the bulk ICOF material is porous and comprises pores with an average diameter from about 0.1 nm to about 6 nm.

In certain embodiments, the size and structure of the internal cavities is dependent on the identity of M⁺. In other embodiments, the porosity and crystallinity of an ICOF of the invention is tuned and/or modified by altering the identity of M⁺.

In certain embodiments, the ICOFs of the invention reversibly adsorb one or more gases selected from the group consisting of H₂, N₂, CH₄, carbon dioxide, ethane, ethylene, acetylene, propane and propene.

In certain embodiments, the ICOFs of the invention are resistant to hydrolysis. In other embodiments, the ICOFs of the invention undergo negligible degradation after being submerged in neutral water for 2 days. In other embodiments, the ICOFs of the invention undergo negligible degradation after being submerged in a 1 M LiOH solution for 2 days. In yet other embodiments, the ICOFs of the invention undergo negligible degradation after being submerged in aqueous solutions for more than 2 days. In yet other embodiments, the ICOFs of the invention undergo negligible degradation after being submerged in aqueous solutions for more than 1 week.

In certain embodiments, the ICOFs of the invention exhibit excellent thermal stability, undergoing a weight loss of less than 25% at 800° C. In other embodiments, the ICOFs of the invention undergo a weight loss of less than 5% at 350° C.

The invention further provides, and compositions comprising building blocks and/or ICOFs of the invention. In certain embodiments, the compositions of the invention are Li⁺-conducting solid electrolytes comprising an ICOF building block of formula (Ia) and/or (Ib) and one or more non-reactive thermoplastic polymers. In certain embodiments, the non-reactive thermoplastic is one or more compounds selected from the group consisting of polyvinylidene fluoride, polyvinyl chloride, polycarbonate, poly(ethylene oxide), polyphenylene oxide, poly(methyl methacrylate), polyethylenimine, acrylonitrile butadiene styrene, nylon, polylactic acid, polybenzimidazole, polyetherether ketone, polyetherimide, polyethylene and polystyrene.

### Methods

The invention provides methods of making ionic covalent organic frameworks of the invention, the method comprising contacting in a solvent B(OR)₃ (wherein each occurrence of R is independently C₁-C₆ alkyl), a proton acceptor and a compound of formula

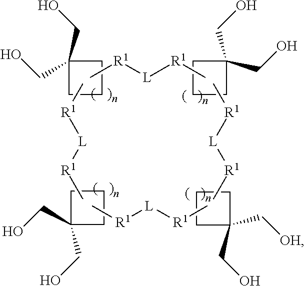

where R¹, L and n are as defined elsewhere herein, to form a mixture.

In certain embodiments, the mixture is allowed to react for a period of about 1 hour to about 2 weeks. In other embodiments, the mixture is allowed to react at room temperature. In yet other embodiments, the mixture is heated to a temperature of about 120° C. In yet other embodiments, the mixture is kept in contact with air or in a sealed vessel.

In certain embodiments, the proton acceptor is an amine. In other embodiments, the proton acceptor is an alkali metal hydroxide. In yet other embodiments, the proton acceptor is one or more compounds selected from the group consisting of LiOH, NaOH, KOH, CsOH, Mg(OH)₂, Ca(OH)₂, Sr(OH)₂, Ba(OH)₂, Al(OH)₃, Fe(OH)₂, Fe(OH)₃, Cr(OH)₂, Cr(OH)₃, Mn(OH)₂, Mn(OH)₃, Co(OH)₂, Co(OH)₃, Ni(OH)₂, Ni(OH)₃, Cu(OH)₂, CuOH, AuOH, Au(OH)₃, Zn(OH)₂, AgOH, Cd(OH)₂, Cd(OH)₃, ammonia, alkylamines, dialkylamines, trialkylamines, arylamines, diarylamines, triarylamines, alkylarylamines, diakylarylamines and alkyldiarylamines.

In certain embodiments, the solvent is any organic solvent common to the art of organic synthesis. In other embodiments, the solvent is one or more solvents selected from the group consisting of dimethylformamide (DMF), tetrahydrofuran (THF), chloroform (CHCl₃) and acetone.

All references throughout this application (for example, patent documents including issued or granted patents or equivalents; patent application publications; and non-patent literature documents or other source material) are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application. In general, the terms and phrases used herein have their art-recognized meaning, which can be found by reference to standard texts, journal references and contexts known to those skilled in the art. Any preceding definitions are provided to clarify their specific use in the context of the invention.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### Examples

The invention is now described with reference to the following Examples. These Examples are provided for the purpose of illustration only, and the invention is not limited to these Examples, but rather encompasses all variations that are evident as a result of the teachings provided herein.

### Materials and Methods

Unless otherwise stated, all commercially available chemicals were used without further purifications. Tetrahydrofuran (THF), dichloromethane and dimethylformamide (DMF) are purified by the MBRAUN® solvent purification systems. All reactions were conducted under inert atmosphere (nitrogen or argon).

Flash column chromatography was performed by using a 100-150 times weight excess of flash silica gel 32-63 μm from DYNAMIC ADSORBENTS INC®. Fractions were analyzed by TLC using TLC silica gel F254 250 μm precoated-plates from SILICYCLE®.

NMR spectra were taken on Inova 400 and Inova 500 spectrometers. Solid-state cross polarization magic angle spinning (CP/MAS) NMR spectra were recorded on an INOVA™ 400 NMR spectrometer. Deuterated solvents were purchased from CAMBRIDGE ISOTOPE LABORATORIES™ (Andover, Mass.) and used as received.

The FT-IR spectra were obtained in the form of KBr pellets, using a THERMO NICOLET AVATAR®-370 spectrometer. Elemental analyses were taken at University of Illinois at Urbana-Champaign, SCS micro-analytical lab. Thermogravimetric analysis (TGA) was performed on a TA INSTRUMENTS Q-500 SERIES™ thermal gravimetric analyzer by heating the sample under an atmosphere of nitrogen from 50° C. to 850° C. at 10° C./min. The QUANTACHROME AUTOSORB® ASiQ automated gas sorption analyzer was used to measure N₂, adsorption isotherms. The samples were activated by heating at 100° C. under the vacuum for at least 22 hours. Ultra-high purity grade (99.999%) N₂, oil-free valves and gas regulators were used for all free space corrections and measurements. For all of the gas adsorption measurements, the temperatures were controlled by using a refrigerated bath of liquid N₂ (77 K) or by ice water (273 K).

Scanning Electron Microscopy images (SEM) were recorded using a JSM-6480LV (LVSEM) at 15 kV.

Ionic conductivity, transference values, and linear sweep voltammetry were performed on a SOLARTRON frequency response analyzer (1250B) and electrochemical interface (1287).

### Synthesis of Dimethyl 3, 6-dibromo-9H-fluorene-9,9-dicarboxylate (S2)

To a solution of 3,6-dibromo-9H-fluorene (5.3 g, 16.4 mmol) in THF (50 mL) was added LDA (18 mL) at −78° C., and the mixture was stirred at −78° C. for 3 h. Then MeOCOCl (6.3 mL) was added dropwise to the above solution. The reaction was slowly warmed up to rt and the mixture was stirred for 19 h. Then, the reaction was quenched by the addition of aq. NH₄Cl solution (10 mL). The mixture was washed with methylene chloride (100 mL) and brine (100 mL) and dried over anhydrous Na₂SO₄. The volatiles were removed and the residue was purified by flash column chromatography (gradient elution with a mixture of hexane and CH₂Cl₂, v:v, 50:1→1:1). The product S2 was obtained as a white solid (6.4 g, 65%), along with the recovered starting material S1 (1.5 g). Physical data of S2: ¹H NMR (500 MHz, CDCl₃) δ 7.82 (d, J=1.9 Hz, 2H), 7.67 (d, J=8.2 Hz, 2H), 7.53 (dd, J=8.2, 1.9 Hz, 2H), 3.77 (s, 6H); ¹³C NMR (400 MHz, CDCl₃) δ 167.9, 141.9, 138.9, 131.4, 128.3, 123.8, 123.5, 67.5, 53.7; HRMS (ESI, m/z) Cald. for C₁₇H₁₂Br₂LiO₄ [M+Li]+:446.9242, Found: 446.9233.

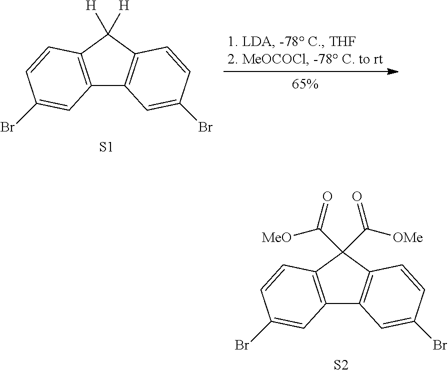

### Synthesis of Dimethyl 3,6-di(prop-1-yn-1-yl)-9H-fluorene-9,9-dicarboxylate (S3)

A mixture of dibromide S2 (6.4 g, 14.5 mmol), PdCl₂(PPh₃) (514 mg, 0.73 mmol), CuI (56 mg, 0.29 mmol) and Et₃N (7.6 mL, 150 mmol) in THF (180 mL) was degassed through three evacuation and nitrogen refill cycles. Propyne was bubbled through the above mixture for ca. 5 min. Then the Schlenk tube was sealed and the mixture was heated for 24 h at 70° C. After cooling to rt, the reaction mixture was concentrated and the residue was purified by flash column chromatography (hexanes:CH₂Cl₂, 1:1) to give the product as a yellow solid (4.9 g, 94%): ¹H NMR (500 MHz, CDCl₃) δ 7.70 (dd, J=4.7, 3.1 Hz, 4H), 7.40 (dd, J=8.0, 1.5 Hz, 2H), 3.76 (s, 6H), 2.10 (s, 6H); ¹³C NMR (400 MHz, CDCl₃) δ 168.6, 140.7, 139.1, 131.3, 126.5, 125.1, 123.0, 86.8, 79.5, 67.9, 53.5, 4.4; HRMS (ESI, m/z): calcd. For C₂₃H₁₈O₄Li [M+Li]+: 365.1365, Found: 365.1365.

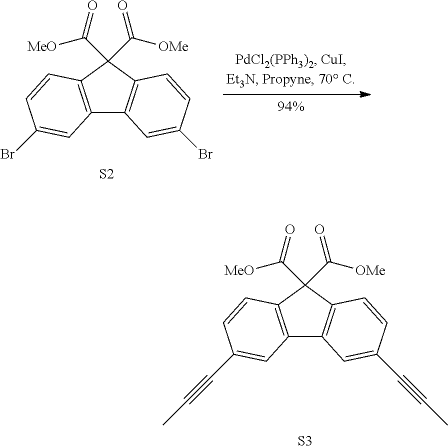

### Synthesis of Methyl 3,6-di(prop-1-yn-1-yl)-9H-fluorene-9-carboxylate (S4)

To a solution of LiAlH₄ (1.18 g, 31.1 mmol) in THF (90 mL) was added the solution of compound S3 (2.79 g, 7.78 mmol) in THF (20 mL) at 0° C. dropwise. The reaction was stirred at rt for 2 h, and then quenched by the addition of water (100 mL, degassed). The mixture was stirred for 10 min under nitrogen, then diluted with CH₂Cl₂ (100 mL). The organic layer was separated and the aqueous solution was extracted with CH₂Cl₂ (50 mL). The combined organic extracts were washed with brine (100 mL), dried over anhydrous Na₂SO₄, and concentrated. The residue was purified by flash column chromatography (gradient elution, CH₂Cl₂:hexanes, 1:2; then pure CH₂Cl₂, then CH₂Cl₂: i-PrOH, 30:1) to give the compound 1 (424 mg, 18%) as a white solid. Compound S4 (1.71 g, 73%) was obtained as a side product, which can be converted to 1 through one carbon homologation (NaOtBu, (CH₂O)ₙ, DMSO, rt, >90%) followed by reduction (LiAlH₄, 70%). Physical data for 1: ¹H NMR (400 MHz, CDCl₃) δ 7.72 (dd, J=1.5, 0.7 Hz, 2H), 7.52 (dd, J=7.9, 0.7 Hz, 2H), 7.28 (dd, J=7.8, 1.5 Hz, 2H), 3.82 (s, 4H), 2.02 (s, 6H); ¹³C NMR (400 MHz, CDCl₃) δ 145.2, 140.4, 130.8, 124.4, 123.9, 123.3, 86.1, 79.6, 66.5, 57.2, 4.4; HRMS (ESI): calcd. for C₂₁H₁₈O₂Li [M+Li]+: 309.1467, Found: 309.1476. Physical data for S4: ¹H NMR (500 MHz, CDCl₃) δ 7.75 (d, J=1.5 Hz, 2H), 7.58 (dd, J=7.7, 0.9 Hz, 2H), 7.39 (dd, J=7.9, 1.5 Hz, 2H), 4.85 (s, 1H), 3.76 (s, 3H), 2.11 (s, 6H); ¹³C NMR (400 MHz, CDCl₃) δ 170.7, 140.8, 139.9, 130.9, 125.5, 124.0, 123.1, 86.2, 79.7, 53.2, 52.7, 4.4; HRMS (ESI, m/z) calcd. for C₂₁H₁₆O₂Li [M+Li]+: 307.1310, Found: 307.1320.

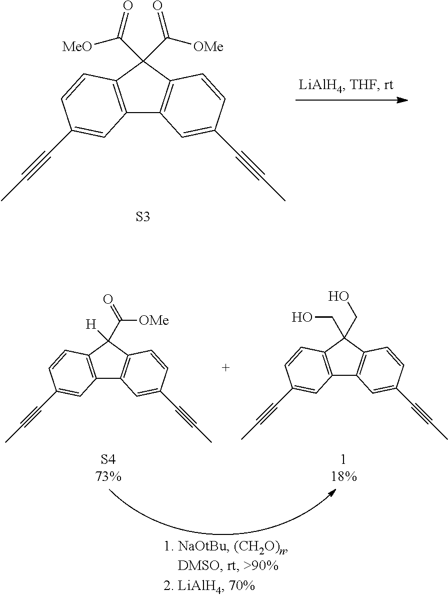

### Synthesis of Model Compound 2

A mixture of compound 1 (10 mg, 0.033 mmol), B(OMe)₃ (1.84 μL, 0.0165 mmol) and (CH₃)₂NH (8.27 μL, 0.0165 mmol, 2 M in THF) in CDCl₃ (2 mL) was stirred at rt. The reaction was monitored by ¹H NMR spectroscopy. The reaction proceeds quickly, reaching 59% conversion within 1 min and almost complete conversion within an hour. NMR data for 2: ¹H NMR (400 MHz, CDCl3) δ 7.73 (s, 4H), 7.49 (brs, 4H), 7.34 (d, J=5.0 Hz, 4H), 4.05 (s, 4H), 2.08 (s, 12H); 2.41 (s, 6H, 1 equiv, amine), 3.51 (s, 9H, 3 equiv. MeOH generated during the reaction); HRMS (ESI, m/z): calcd. For C₄₂H₃₂BO₄— [M]−: 611.2399, Found: 611.2327.

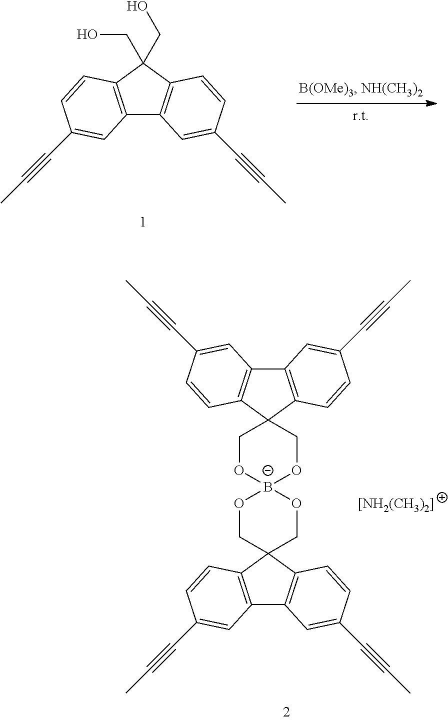

### Synthesis of (3,6-di (prop-1-yn-1-yl)-9H-fluorene-9, 9-diyl)bis(methylene)diacetate (3)

A solution of compound 1 (1.86 g, 6.15 mmol), CH₃COCl (1.11 mL, 15.6 mmol), DMAP (77.1 mg, 0.63 mmol), and Et₃N (2.58 mL, 18.5 mmol) in CH₂Cl₂ (95 mL) was stirred at rt for 3 h. The reaction was quenched by the addition of water (10 mL). The product was extracted with CH₂Cl₂ (50 mL×3). The combined organics were washed with brine (100 mL), and dried over anhydrous Na₂SO₄. The volatiles were removed under reduced pressure and the residue was purified by flash column chromatography (elution, CH₂Cl₂) to yield the compound 3 as a white solid (2.38 g, quantitative): ¹H NMR (500 MHz, CDCl₃) δ 7.75-7.70 (m, 2H), 7.50-7.44 (m, 2H), 7.34 (dd, J=7.8, 1.5 Hz, 2H), 4.30 (s, 4H), 2.08 (s, 6H), 2.06 (s, 6H); ¹³C NMR (400 MHz, CDCl₃) δ 170.6, 143.9, 140.2, 130.9, 124.7, 124.5, 123.3, 86.5, 79.5, 65.5, 52.8, 20.8, 4.4; HRMS (ESI, m/z): Calcd. for C₂₅H₂₂O₄Li [M+Li]+: 393.1678, Found: 393.1672.

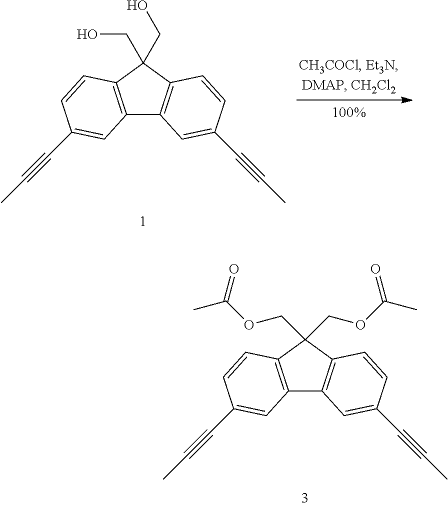

### Synthesis of Macrocycle 4

The 6,6′,6″-((methylsilanetriyl)tris(methylene))tris(2-methylphenol) ligand (38 mg, 0.095 mmol) and the molybdenum precursor (64 mg, 0.095 mmol) were mixed in dry carbon tetrachloride (6 mL) and the mixture was stirred for 15 minutes to generate the catalyst in situ. To a suspension of the compound 3 (1.23 g, 3.18 mmol) and 5 Å molecular sieves (4.8 g) in CHCl₃ (20 mL) was added the above catalyst solution. The mixture was stirred at 55° C. for 15 h. The molecular sieves were removed by centrifugation. The remaining solution was concentrated to give the pure product 4 as a white solid (0.83 g, 78%): ¹H NMR (500 MHz, CDCl₃) δ 8.04-7.95 (s, 2H), 7.59 (d, J=7.6 Hz, 2H), 7.53 (d, J=7.8 Hz, 2H), 4.42 (s, 4H), 2.12 (s, 6H); ¹³C NMR (400 MHz, THF-ds) δ 170.4, 146.6, 141.7, 132.5, 126.1, 124.7, 123.9, 90.8, 66.3, 54.8, 20.5; HRMS (ESI, m/z): calcd. for C₈₄H₆₄LiO₁₆ [M+Li]+: 1335.4349, Found: 1335.9236.

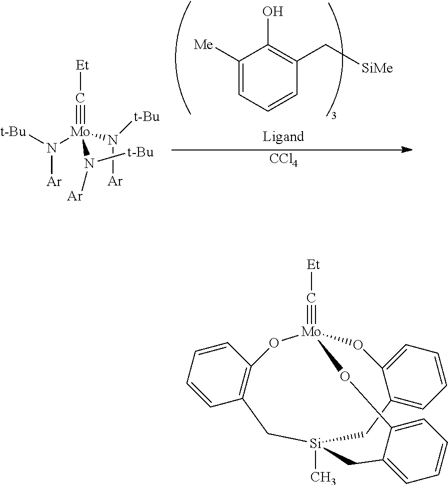

### Synthesis of Macrocycle 5

The suspension of compound 4 (783 mg, 0.59 mmol), K₂CO₃ (0.61 g, 4.4 mmol) in MeOH (90 mL) was refluxed for 24 h. The solid was collected by centrifugation, washed with MeOH and water, and dried under vacuum to give macrocycle 5 (471 mg, 97%): ¹H NMR (400 MHz, DMSO-d6) δ 8.17 (d, J=1.7 Hz, 2H), 7.70 (d, J=7.8 Hz, 2H), 7.59 (dd, J=7.8, 1.5 Hz, 2H), 5.00 (t, J=5.3 Hz, 2H), 3.78 (d, J=5.1 Hz, 4H); ¹³C NMR (400 MHz, DMF-d7) δ 149.0, 141.0, 131.2, 125.8, 122.8, 122.4, 89.8, 64.6, 59.1; HRMS (ESI, m/z): calcd. for C₆₈H₄₈O₈Li [M+Li]+: 999.3511, Found: 999.5823.

| Peak (cm⁻¹) | Assignment and Notes |
|---|---|
| 3220 (m) | O—H stretch from hydroxyl groups |
| 2925 (w) | C—H stretching |
| 2876 (w) | |
| 2206 (w) | C≡C stretch |
| 1743 (w) | Comb useful for determining substitution |
| | patterns in 6-membered aromatic rings |
| 1611 (w) | C═C stretch in typical region for fused |
| 1560 (w) | aromatics |
| 1490 (m) | δC—H band of CH₂ |
| 1369 (s) | δC—O—H, characteristic band for alcohol |
| 1123 (w) | C—H in plane bending modes |
| 1078 (m) | |
| 1025 (s) | C—O stretch, characteristic band for alcohol |
| 877 (m) | C—H out of plane bands for p- substituted |
| 828 (m) | aromatic |
| 730 (m) | |

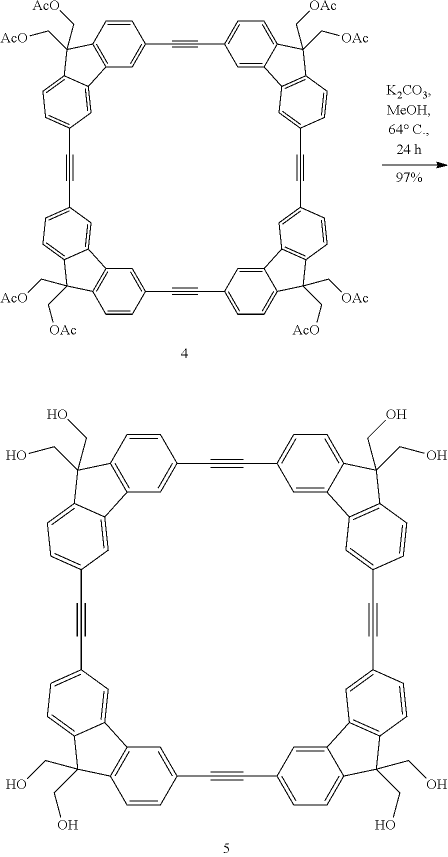 [SMILES: CC(=O)OCC1(COC(C)=O)c2ccc3cc2-c2cc(ccc21)C#Cc1ccc2c(c1)-c1cc(ccc1C2(COC(C)=O)COC(C)=O)C#Cc1ccc2c(c1)-c1cc(ccc1C2(COC(C)=O)COC(C)=O)C#Cc1ccc2c(c1)-c1cc(ccc1C2(COC(C)=O)COC(C)=O)C#C3 ; OCC1(CO)c2ccc3cc2-c2cc(ccc21)C#Cc1ccc2c(c1)-c1cc(ccc1C2(CO)CO)C#Cc1ccc2c(c1)-c1cc(ccc1C2(CO)CO)C#Cc1ccc2c(c1)-c1cc(ccc1C2(CO)CO)C#C3]

### Synthesis of ICOF-1

Macrocycle 5 (150 mg, 0.15 mmol) was suspended in DMF (17 mL) for 15 h overnight. To the suspension were added B(OMe)₃ (33.7 μL, 31.3 mg, 0.30 mmol) and (CH₃)₂NH (227 μL, 0.445 mmol, 2.0 M in THF). The mixture was sealed and heated at 120° C. for 7 days. The precipitates were collected by centrifugation, washed with anhydrous acetone, and dried under vacuum overnight, to give a brown solid (122 mg, 72%): CP-MAS ¹³C NMR (100 MHz) δ 147.5, 139.9, 131.9, 123.19, 90.1, 70.2, 54.5, 44.9, 38.1; CP-MAS ¹¹B NMR (128 MHz) 14.2, 7.4, 2.2; Elemental Analysis: calcd. For (C₇₂H₅₆B₂N₂O₈)n: C (78.70), H (5.14), N (2.55), B (1.97), found C (78.22), H (4.37), N (0.57), B (1.33); BET surface area 1022 m²·g⁻¹. This batch of ICOF-1 was used in all the experiment unless otherwise specified. See FIG. 2B for synthetic scheme.

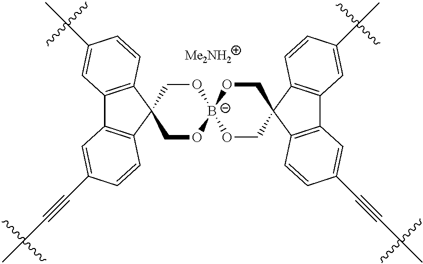

| Peak (cm⁻¹⁾ | Assignment and Notes |
|---|---|
| 3400 (w) | N—H stretch and comb, O—H stretch from hydroxyl |
| | groups |
| 2912 (w) 2840 (w) | C—H stretch |
| 2191 (w) | C≡C stretch |
| 1610 (w) 1577 (w) | C═C stretch in typical region for fused aromatics |
| 1476 (m) | δC—H band of CH₂ |
| 1418 (m) | B—O stretch |
| 1320 (m) | δC—O—H, characteristic band for alcohol |
| 1132 (w) 1054 (m) | C—H in plane bending modes |
| 1099 (m) | C—O stretch, characteristic band for alcohol |
| 871 (m) 820 (m) | C—H out of plane bands for p- substituted aromatic |

### Synthesis of ICOF-2

Macrocycle 5 (150 mg, 0.15 mmol) was suspended in DMF (17 mL) for 15 h overnight. To the suspension were added B(OMe)₃ (33.7 μL, 31.3 mg, 0.30 mmol) and LiOH (7.5 mg, 0.30 mmol). The mixture was sealed and heated at 120° C. for 7 days. The precipitates were collected by centrifugation, washed with anhydrous acetone, and dried under vacuum overnight, to give a brown solid (96 mg, 62%): CP-MAS ¹³C NMR (100 MHz) δ 147.2, 139.1, 131.6, 130.1, 123.2, 108.3, 90.9, 70.1, 52.9, 45.8, 38.1; CP-MAS ¹¹B NMR (128 MHz) 14.3, 1.3 ppm; Elemental Analysis: calcd. For (C₆₈H₄₀B₂Li₂O₈)ₙ: C (80.03), H (3.95), B (2.12), Li (1.36); found C (80.74), H (5.31), B (1.26), Li (0.72); BET surface area 1259 m²·g⁻¹. This batch of ICOF-2 was used in all the experiment unless otherwise specified. See FIG. 2B for synthetic scheme.

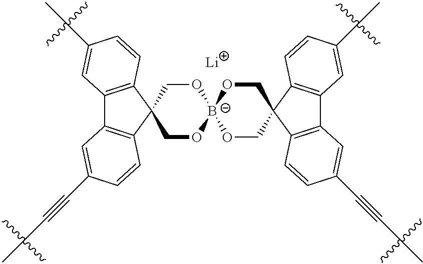

| Peak (cm⁻1) | Assignement and Notes |
|---|---|
| 3415 (w) | N—H stretch and com, O—H stretch from hydroxyl |
| | groups |
| 2921 (w) | C—H stretch |
| 2844 (w) | |
| 2191 (w) | C≡C stretch |
| 1606 (w) 1557 (w) | C═C stretch in typical region for fused aromatics |
| 1490 (m) | δC—H band of CH₂ |
| 1434 (s) | B—O stretch |
| 1404 (m) | δC—O—H, characteristic band for alcohol |
| 1158 (w) 1021 (m) | C—H in plane bending modes |
| 1021 (m) | C—O stretch, characteristic band for alcohol |
| 875 (m) 830 (m) 730 (m) | C—H out of plane bands for p- substituted aromatic |

### Thermal Gravimetric Analysis of ICOF-1 and ICOF-2:

Samples were run on a TA Instruments Q-500 series thermal gravimetric analyzer with samples held in a platinum pan under nitrogen atmosphere. A 10 K min⁻¹ ramp rate was used. Both ICOF-1 and ICOF-2 exhibit good thermal stability, showing a weight loss −20-30% at 800° C.

### Water, Acid and Base Treatments of ICOF-1 and ICOF-2:

ICOF-1 or ICOF-2 (30 mg) were submerged in either water (3 mL), an aqueous solution of 1 M HCl (3 mL) or an aqueous solution of 1 M LiOH (3 mL), and the mixture was stirred for 2 days. The mixture was centrifuged and the solution was carefully decanted. The remaining ICOF-1 or ICOF-2 was then washed with acetone and dried under vacuum. In all instances, the aqueous solutions gave no weighable and detectable (by ¹H NMR) residues after evaporation.

### Lithium Conductivity Measurements of ICOF-2:

ICOF-2 was mixed with polyvinylidene fluoride (PVDF) in a 2:1 weight ratio in N-methyl-2-pyrrolidone (NMP) and subsequently bladed onto aluminum foil. The film was dried at 80° C. overnight eventually peeling off the aluminum to form a freestanding membrane. Discs of Φ=1.3 cm were punched from the dried film and further dried at 120° C. under vacuum to remove any residual moisture and NMP. Discs were then soaked in propylene carbonate (PC) for 24 hours before characterization. Discs were then transferred to an Ar environment where all electrochemical cell preparation and testing took place.

Ionic conductivity measurements were made by sandwiching the soaked punches between titanium electrodes in a custom pressure cell. The cell was heated to 80° C. for 2 hours to ensure proper electrode contact. The measurements were taken using a Solartron 1280C with a 10 mV amplitude between 1 MHz to 1 Hz on a cooling process, equilibrating the temperature for 1 hour between tests. Typical equivalent circuits for ion blocking electrodes fit to the data in conjuncture with equation 1 to back out resistance and thus conductivity values. Activation energy is determined from the slope of the Arrhenius plot.

$$σ = \frac{l}{R * A} \qquad ( 1 )$$

Lithium ion transference number is calculated using the Bruce-Vincent-Evans (BVE) technique as in equation 2. ICOF-2: PVDF film is constructed into a symmetric lithium cell (lithium/ICOF-2: PVDF/lithium); lithium is scraped prior to use to remove any native layer. BVE requires the measurement of initial and steady-state current, I₀ and I_{S}, respectively, for a given DC polarization, ΔV. Initial and steady-state resistance values, R₀ and R_{S}, are determined through AC Impedance using the same test as before. Steady-state is determined once less than a 1% change in current occurred in a 10 minute period.

$${t}_{Li +} = \frac{IS ( Δ V - I 0 R 0 )}{I 0 ( Δ V - ISRS )} \qquad ( 2 )$$

Electrochemical stability is tested using linear sweep voltammetry (LSV) with a lithium/ICOF-2: PVDF/titanium construction at a scan rate of 1 mV s⁻¹. LSVs are performed from OCV up to 6 V and down to 0.2 V corresponding to anodic and cathodic sweeps, respectively.

### Example 1: Transesterification of Model Compounds

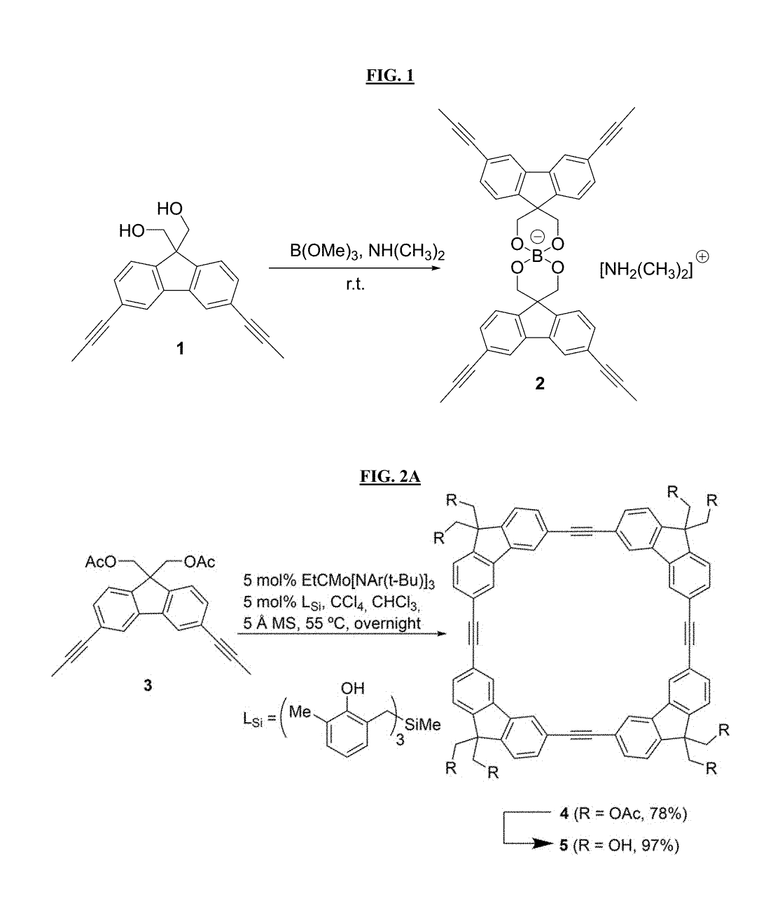

In order to explore the potential for forming tetra-coordinated borate-linked ionic COFs, the transesterification of a model diol 1 was studied. Formation of the tetra-coordinated borate linkage proceeded with release of a proton and was thus favored in the presence of proton acceptors. In the presence of dimethyl amine, nearly complete conversion of diol compound 1 to product compound 2 occurred within 60 minutes at room temperature. The reaction proceeded much more sluggishly in the absence of base (FIG. 1).

### Example 2: Formation of Tetra-Coordinated Borate Linked COFs

Based on the findings from the model compound experiments, the formation of COFs linked by tetra-coordinated borates was explored. A D₄-symmetric macrocycle 5 equipped with four diol groups as multifunctional building blocks was synthesized. Macrocycle 5 was readily obtained from compound 3 in two steps through alkyne metathesis cyclo-oligomerization followed by de-protection (FIG. 2A). These shape-persistent macrocycles represent a new type of nano-sized building block containing preexisting non-collapsible internal cavities.

The formation of tetra-coordinated borate-linked COFs was tested through the condensation of 5 and trimethyl borate under similar conditions to the model compounds, using dimethylamine as a base. Dimethylformamide (DMF) was used as a solvent. The reaction was carried out at 120° C. for 7 days in nitrogen. A gray gel was formed gradually during the reaction, which was collected by centrifugation and washed with acetone to yield ICOF-1, a (Me₂NH₂)⁺ ICOF salt, in a 72% yield. An advantage of ionic tetra-coordinated borate linkages is the easy tunability of counterions which can have profound effects on the material's properties, including gas adsorption capacity and ion conductivity. To demonstrate this, a similar condensation of 5 and trimethyl borate was carried out using LiOH as a base yielding ICOF-2, a Li⁺ ICOF salt in a 62% yield.

ICOF-1 and ICOF-2 were characterized by FT-IR and ¹³C magic-angle spinning (MAS) NMR spectroscopy, elemental analysis, thermogravimetric analysis (TGA), scanning electron microscopy (SEM), and powder X-ray diffraction (PXRD) analysis. The FT-IR spectra of ICOF-1 and ICOF-2 show the absorption bands, respectively, at 1401 and 1435 cm⁻¹, which are characteristic for the stretching of the borate ester bond (B—O). A similar B—O stretching band (1418 cm⁻¹) was also observed in the IR spectrum of model compound 2. The O—H stretch from the hydroxy groups of macrocycle 5 is nearly absent in the IR spectrum of ICOF-2, indicating the successful formation of tetra-coordinated borate linkages from diol functional groups of 5. The broad absorption band around 3410 cm⁻¹ in the IR spectrum of ICOF-1 likely corresponds to the NH stretch of the [Me₂NH₂]⁺ counterion. In the MAS solid-state ¹³C NMR spectrum of ICOF-1, singlets were observed at 90.1, 70.2, and 54.5 ppm, corresponding to the ethynylene carbon atoms, methylene carbon next to the hydroxy groups, and the quaternary carbon in the fluorene ring, respectively. The carbon resonance of [Me₂NH_{2]}⁺ was observed as a singlet at 38.6 ppm. Solid-state ¹³C NMR spectra of ICOF-2 shows similar singlets at 90.9, 72.1, and 52.9 ppm, but with the absence of the peak around 38.6 ppm, supporting the replacement of [Me₂NH_{2]}⁺ with lithium cations.

### Example 3: ICOF Stability Studies

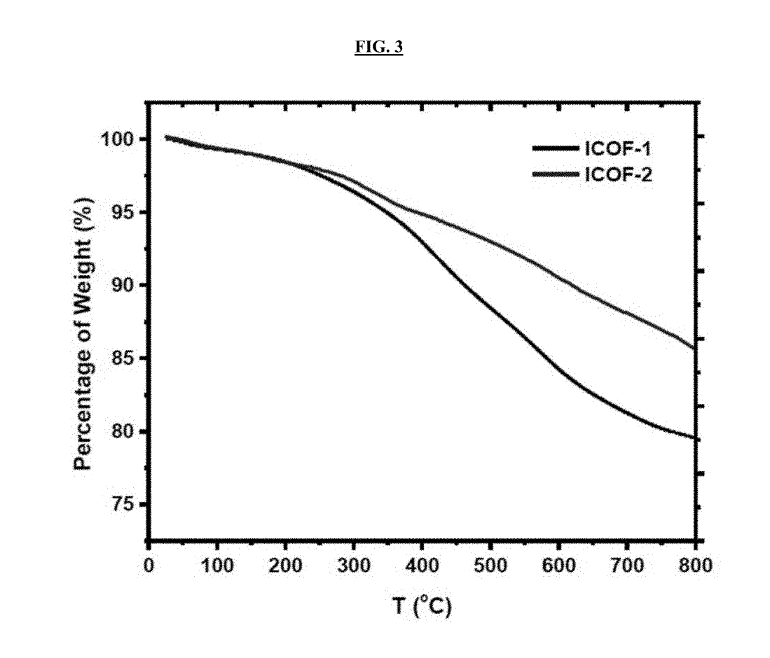

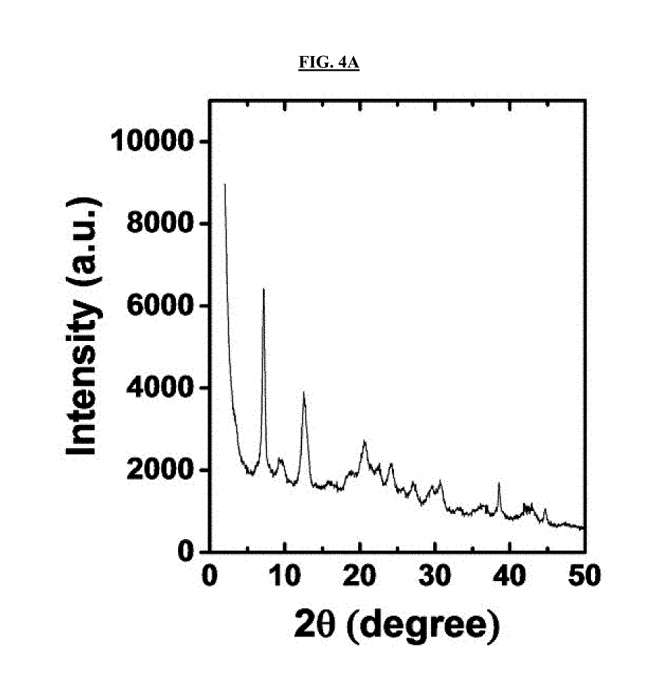

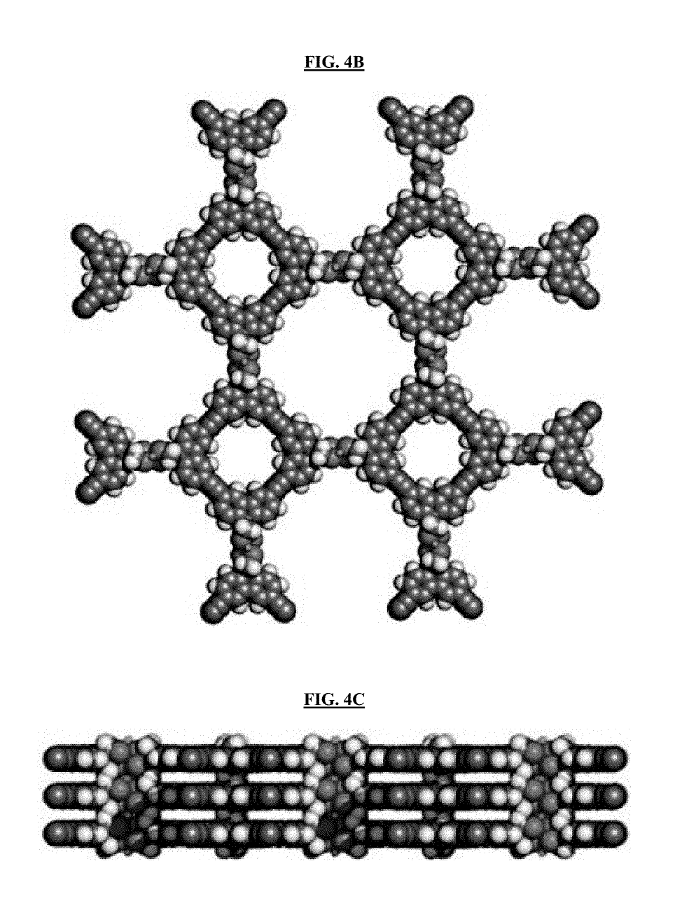

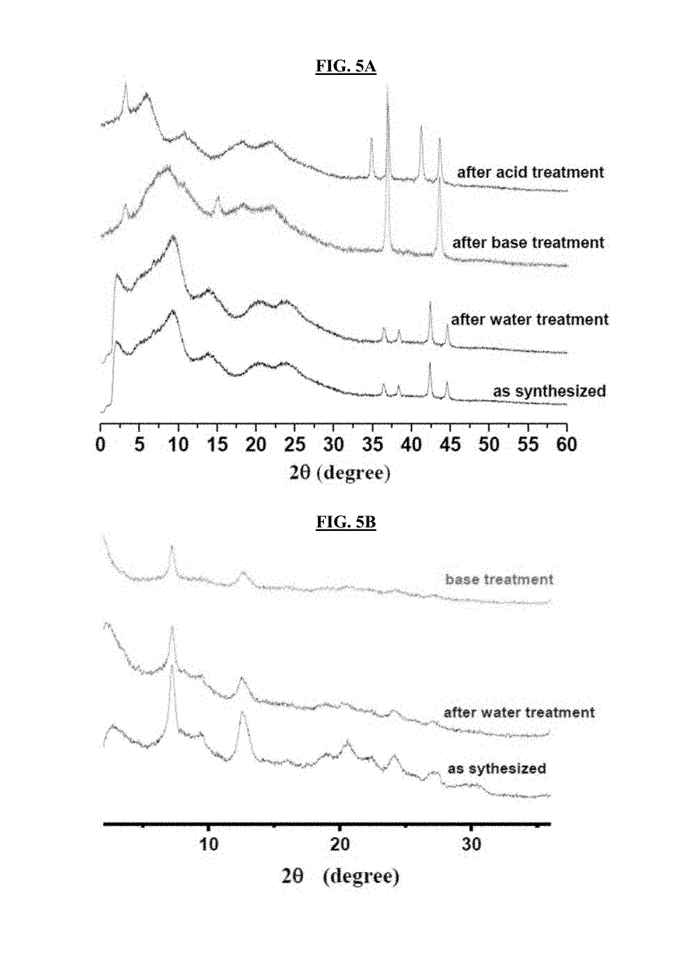

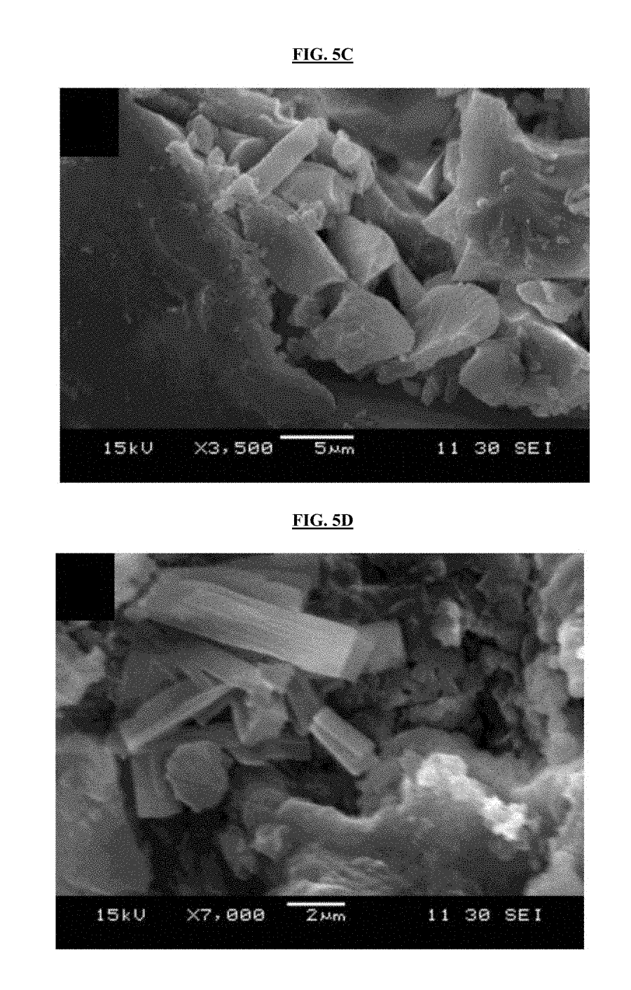

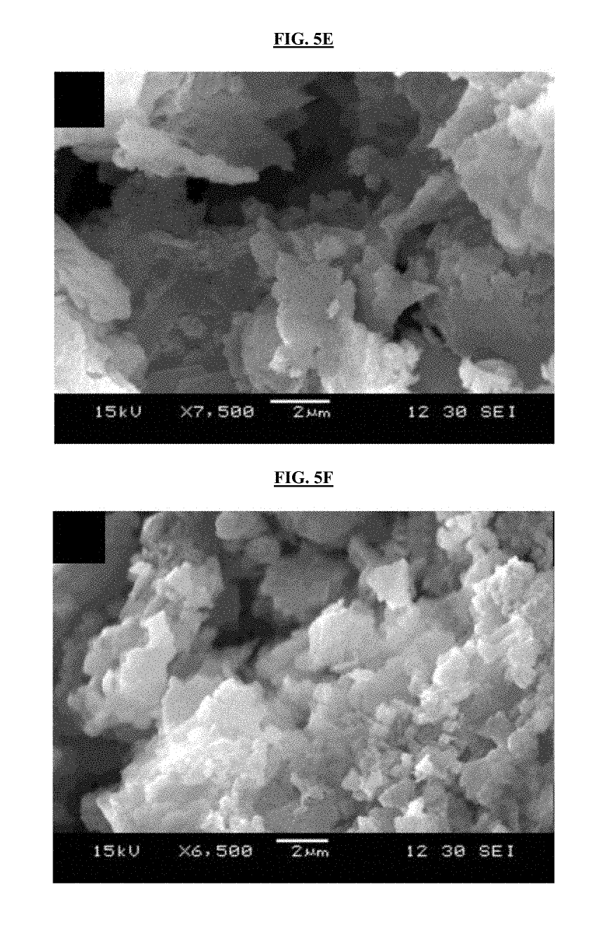

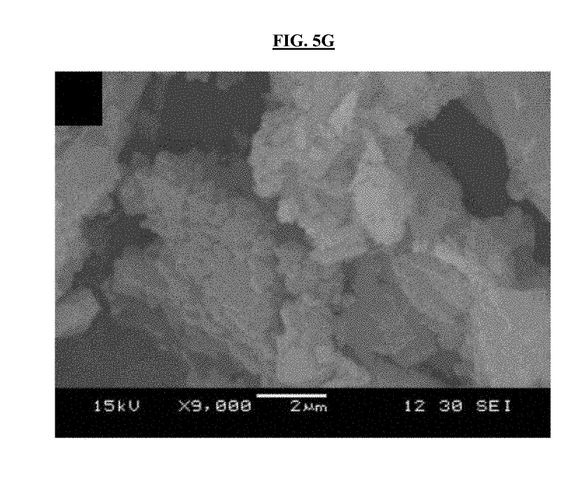

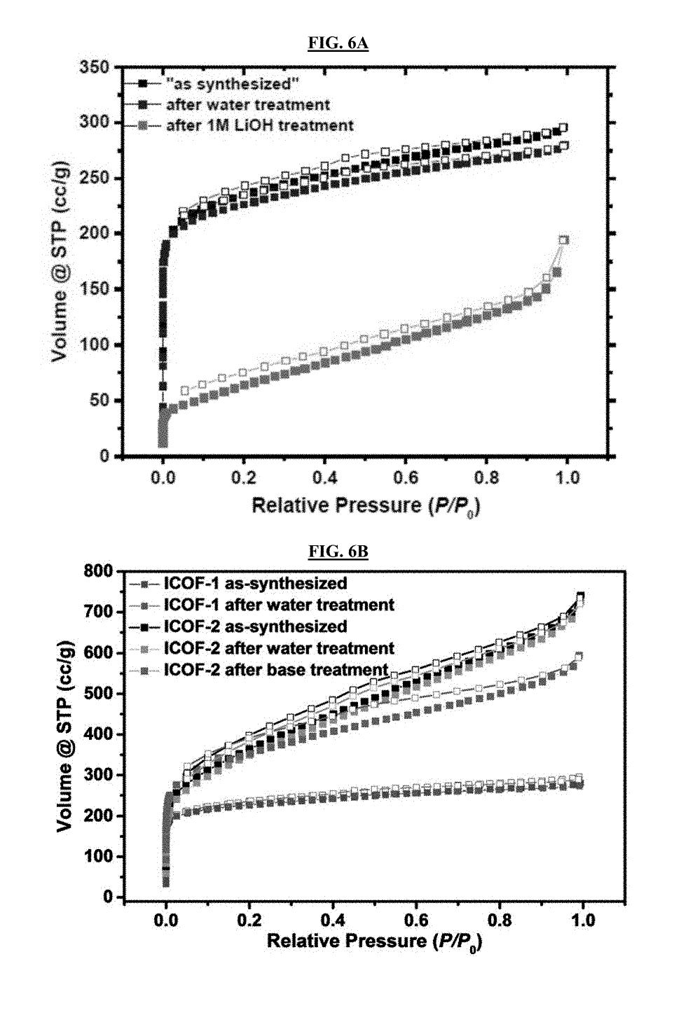

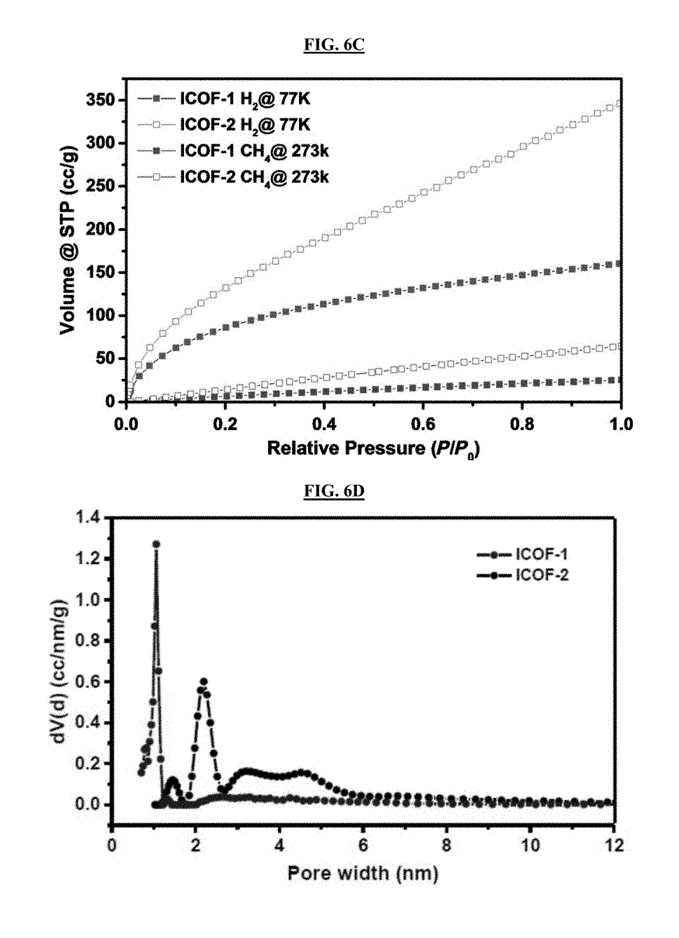

Thermogravimetric analysis (FIG. 3) shows a very gradual onset of weight loss for both ICOF-1 and ICOF-2 and precise determination of the onset temperature was difficult. Both ICOF-1 and ICOF-2 exhibited good thermal stability, showing weight loss of 7-12% at 400° C. in nitrogen atmosphere. SEM images of ICOF-1 and ICOF-2 support their single crystalline morphology (FIGS. 5C-5G). The PXRD characterization (FIGS. 4A, 5A-5B) of ICOF-1 and ICOF-2 shows multiple peaks in the 2θ range of 2-35° indicating certain structure orderliness in the framework. The base used in the reaction affected the crystallinity of the resulting ICOFs, presumably because of their different size, solubility in the reaction medium and also counter cation effect. When LiOH (low solubility) was used as the base, the resulting ICOF-2 showed better crystallinity. The conversion of ICOF-1 to more crystalline ICOF-2 was attempted through the exchange of counter cations by soaking the framework in 1 M LiOH solution. However, a significant BET surface area decrease was observed in ICOF-1 (1022 m²g⁻¹ vs. 210 m²g⁻¹) without improvement of crystallinity (FIG. 6A).

Commonly used boronate ester (or boroxine) linkages in COF synthesis contain Lewis acidic boron centers, which are often prone to hydrolytic decomposition even in atmospheric moisture at ambient temperature. Without being limited to any single theory, the additional Lewis base coordination to boron in anionic spirocyclic esters can make the hydrolysis reaction less favorable. The stability of ICOFs toward hydrolysis was thus investigated. Both ICOF-1 and ICOF-2 showed great stability in water. No significant changes in the BET surface areas and PXRD spectra were observed between the samples before and after immersion in water for 2 days (FIG. 6B). ICOF-2 also exhibits good stability under basic condition (1M LiOH, 2 days), showing similar PXRD spectrum and slight decrease in BET surface area (1259 vs. 1105 m²g⁻¹) compared to those of the fresh sample before the base treatment. No organic residues were observed in the water and base solutions after the treatment, which further confirms the excellent hydrolytic stability of ICOFs. Although no soluble residues were collected in the aqueous phase after the treatment with stronger bases, ICOF-2 shows decrease of the surface area: 8% decrease when stirred in 6M LiOH, for 24 h, and a 72% decrease when stirred in 12M LiOH for 24 h. Both ICOFs are unstable in aqueous acidic solution, because of the acid-labile nature of tetra-coordinated borates.

### Example 4: Gas Adsorption Properties of ICOF-1 and ICOF-2

Gas adsorption properties of the ICOF materials were then investigated. Prior to porosity measurements, all samples were degassed in dynamic vacuum for 24 h at 100° C. As shown in FIG. 6B, ICOF-1 shows typical type I adsorption behavior at 77 K with a rapid uptake at low relative pressure (P/P₀<0.01), indicating its permanent microporous nature. In contrast, the isotherm of ICOF-2 is the intermediate of type I and type IV, showing more pronounced continuous uptake beyond P/P₀=0.05 with apparent hysteresis. The non-local density functional theory (NLDFT) pore-size distribution analysis shows that ICOF-1 has micropores centered around 1.1 nm, while ICOF-2 has mesopores centered around 2.2 nm together with larger mesopores in the range of 2-6 nm (FIG. 6D). Brunauer-Emmett-Teller (BET) surface areas of ICOF-1 and ICOF-2 are 1022 and 1259 m²g⁻¹, respectively.

ICOF-2, containing a Li⁺ counterion, was examined for the adsorption of alternative energy source gases, hydrogen and methane. The material showed excellent adsorption capacities towards H₂ (3.11 wt %, 77 K, 1 bar) and CH₄ (4.62 wt %, 273 K, 1 bar), which are among the highest in all organic porous materials that have been reported, and even competitive with the best reported MOFs under the same conditions. ICOF-1 exhibited more than a two-fold decreases of the H₂ and CH₄ uptakes in compared to ICOF-2 (FIG. 6C), which suggests that the cations play a significant role in improving gas uptake. Therefore, the ionic tetra-coordinated borate synthetic approach represents an interesting alternative strategy for doping of COFs with metal cations to maximize the adsorption of hydrogen.

### Example 5: Lithium-Conducting Solid Electrolyte Tests

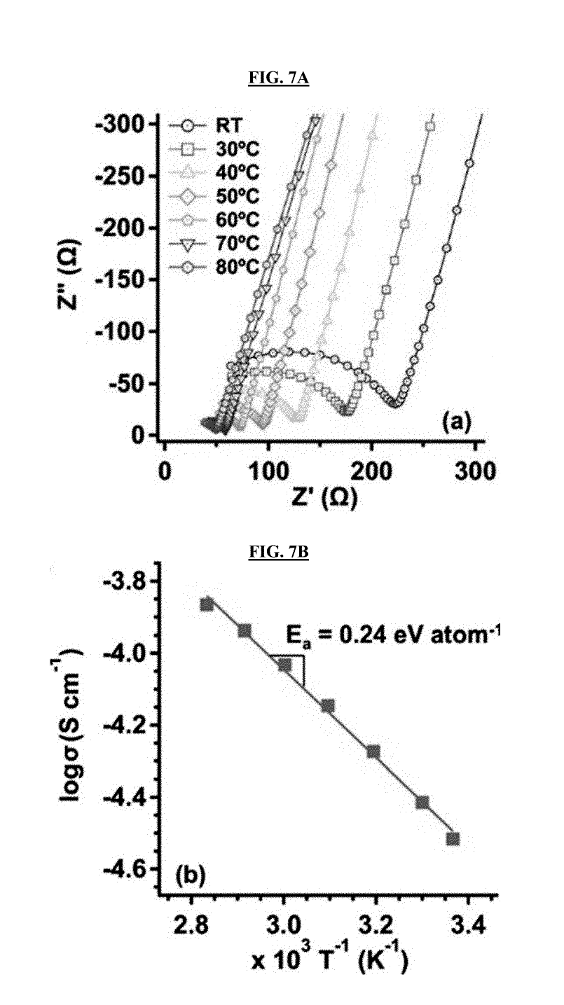

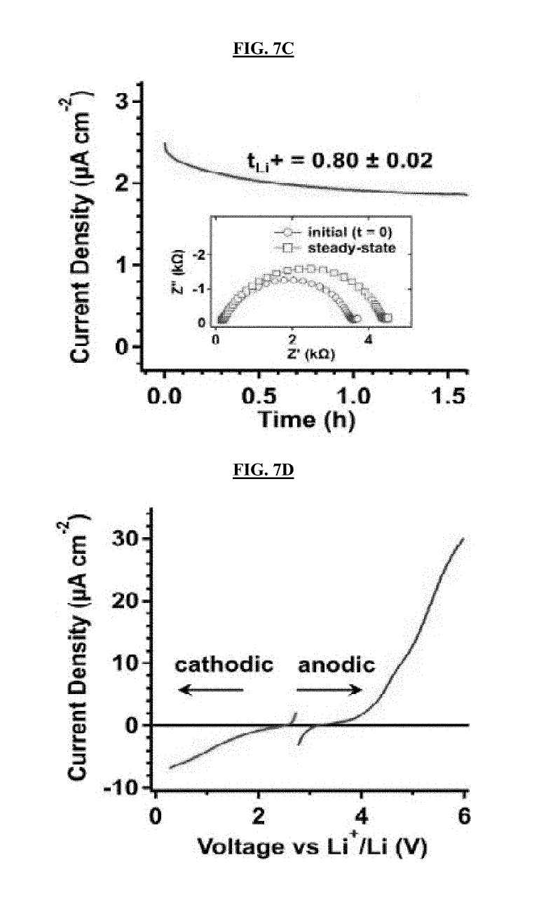

Given the unique porous and ionic nature of these ICOFs, the Li⁺-containing ICOF-2 is envisioned as a Li-conducting solid electrolyte, advantageously being lightweight and possessing high thermal and chemical stability. Thus, the ion conductivity of the novel ICOFs was tested. ICOF-2 microcrystals were mixed with polyvinylidene fluoride (PVDF) in a 2:1 weight ratio in N-methyl-2-pyrrolidone (NMP) and subsequently bladed onto aluminum foil. The film (ICOF-2:PVDF) was dried at 80° C. overnight eventually peeling off the aluminum to form a freestanding membrane. Discs of Φ=1.3 cm were punched from the dried film and further dried at 120° C. in vacuum to remove any residual moisture and NMP. Discs were then soaked in propylene carbonate (PC) for 24 hours before characterization. The PC content in ICOF-2:PVDF was approximately 55 wt % based on thermogravimetric analysis. Nyquist plots (FIG. 7A) of the ICOF-2:PVDF sample show a steep tail at low frequency, confirming the capacitive nature of the electrode/electrolyte interface. Thus a suitable contact was made with the lithium ion blocking electrodes. A room-temperature conductivity of 3.05×10⁻⁵ S cm⁻¹ was observed. No conductivity contribution is expected from PVDF or PC. Because of the frequency and temperature range, contributions could not be separated between grain boundary and bulk conductivity, however, both are included in determining overall conductivity as shown in the Arrhenius plot of FIG. 7B. In contrast to classic polymer electrolytes, which show non-linear activation energy at higher temperatures, ICOF-2 exhibits the linear characteristic of conductivity with temperature, which is typical of ceramic solid conductors. The activation energy of ICOF-2 is 0.24 eV atom⁻¹, a favorable value and comparable to some of the best crystalline solid electrolytes. An average Li transference number value of 0.80±0.02 was determined for ICOF-2 using the Bruce-Vincent-Evans (BVE) method (FIG. 7C). This value is significantly higher than those for typical solid-state polymer electrolytes with dopant lithium salt, which are generally in the range of 0.2-0.5. Lithium ions are not dissolving into the PC to act as a liquid electrolyte, as typical liquid electrolytes have lithium ion transference numbers on the order of 0.50. Without being limited to any one theory, the large resistance increase is most likely from the passivation from the PC on the lithium surface.

A linear sweep voltammetry (LSV) measurement of ICOF-2:PVDF shows a general sloping profile between 0.2 to 4 V because of the resistive nature of the ICOF-2:PVDF membrane at room temperature (FIG. 7D). At above 4.5 V, PC breaks down with lithium, leading to an increase in the observed current. This demonstrates potential compatibility of ICOFs with current high-voltage cathode materials.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A covalent organic framework (COF) comprising the building block of formula (I): 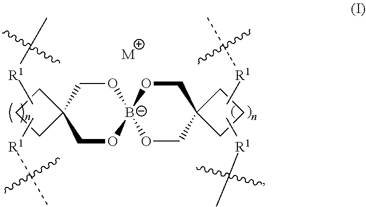
wherein in (I):
n is a number selected from the group consisting of 2 and 3;
each occurrence of R¹ is independently selected from the group consisting of fused C₃-C₁₀ cycloalkylene, fused C₃-C₁₀ heterocyclylene, fused arylene and fused heteroarylene,
wherein the fused C₃-C₁₀ cycloalkylene, fused C₃-C₁₀ heterocyclylene, fused arylene or fused heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl);
M⁺ is a cation selected from the group consisting of Li⁺, Na⁺, K⁺, Cs⁺, Mg²⁺, Ca²⁺, Sr²⁺, Ba²⁺, Al³⁺, Fe²⁺, Fe³⁺, Cr²⁺, Cr³⁺, Mn^{2+,} Mn³⁺, Co²⁺, Co³⁺, Ni^{2+,} Ni³⁺, Cu²⁺, Cu⁺, Au⁺, Au³⁺, Zn²⁺ Ag⁺, Cd²⁺, Cd³⁺, NH₄⁺, R²NH₃⁺, (R²)₂NH₂⁺, (R²)₃NH⁺ and (R²)₄N⁺.
wherein each occurrence of R² is independently selected from the group consisting of C₁-C₁₂ alkyl, C₁-C₆ haloalkyl, C₁-C₆ heteroalkyl, aryl, heteroaryl, C₁-C₆ cycloalkyl and C₁-C₆ heterocyclyl; and
each occurrence of R¹ is covalently bound to a linker L through a single bond depicted as [symbol] , wherein each occurrence of L is independently selected from the group consisting of C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene;
wherein the C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl).

2. The covalent organic framework of claim 1, wherein the building block of formula (I) is the building block of formula (Ia):

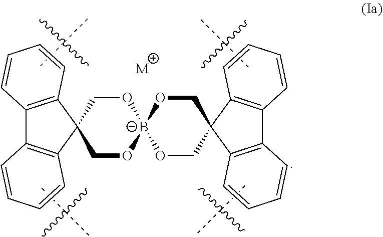

3. The covalent organic framework of claim 1, wherein the building block of formula (I) is the building block of formula (Ib):

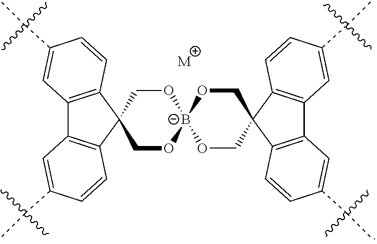

4. The covalent organic framework of claim 1, wherein the building block of formula (I) is further covalently linked to another building block of formula (I) to form:

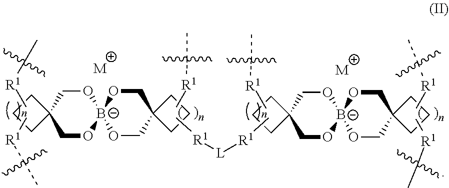

5. The covalent organic framework of claim 2, wherein the building block of formula (Ia) is further covalently linked to another building block of formula (Ia) to form:

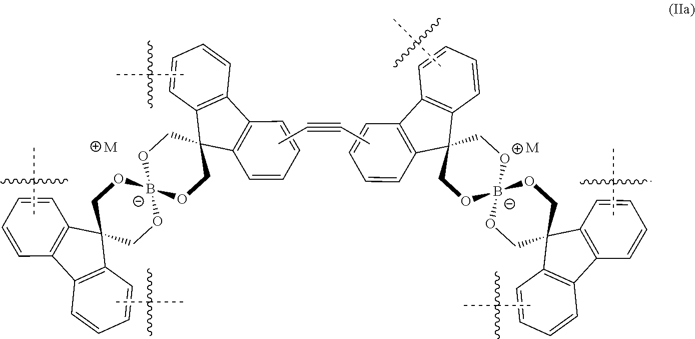

6. The covalent organic framework of claim 3, wherein the building block of formula (Ib) is further covalently linked to another building block of formula (Ib) to form:

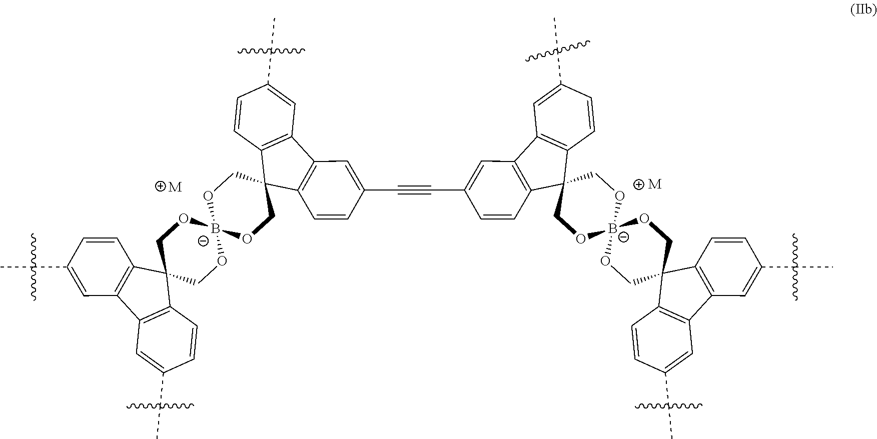

7. The covalent organic framework of claim 1, comprising a compound of formula (III):

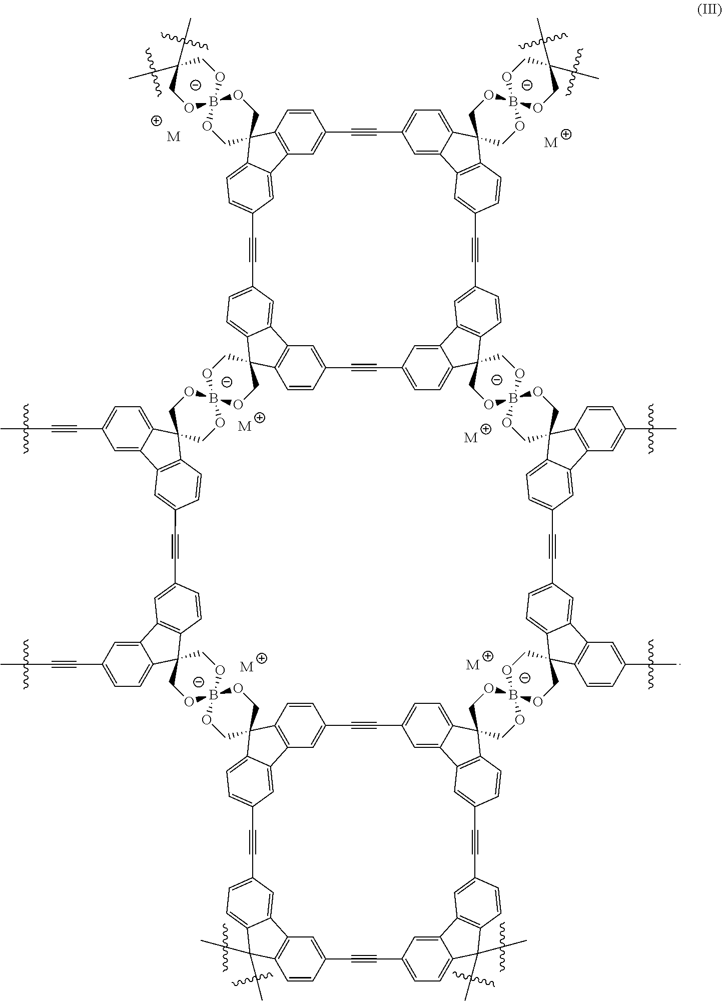

8. The covalent organic framework of claim 1, comprising non-collapsible internal cavities.

9. The covalent organic framework of claim 1, which reversibly adsorbs one or more gases selected from the group consisting of H₂, N₂, CH₄, carbon dioxide, ethane, ethylene, acetylene and carbon monoxide.

10. A Li⁺-conducting solid electrolyte composition comprising the covalent organic framework of any of claims 1-9 and at least one non-reactive thermoplastic polymers.

11. The composition of claim 10, wherein the at least one non-reactive thermoplastic polymer is polyvinylidene fluoride.

12. A method of making an ionic covalent organic framework, the method comprising contacting in an organic solvent B(OR)₃ (wherein each occurrence of R is independently C₁-C₆ alkyl), a proton acceptor and a compound of formula 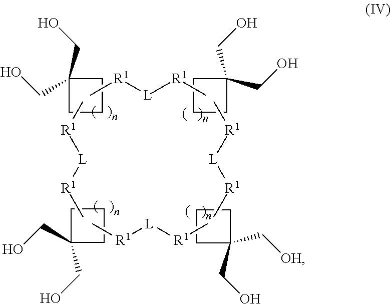
to form a mixture, wherein:
n is a number selected from the group consisting of 2 and 3;
each occurrence of R¹ is independently selected from the group consisting of fused C₃-C₁₀ cycloalkylene, fused C₃-C₁₀ heterocyclylene, fused arylene and fused heteroarylene,
wherein the fused C₃-C₁₀ cycloalkylene, fused C₃-C₁₀ heterocyclylene, fused arylene or fused heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl); and
each occurrence of L is independently selected from the group consisting of C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene;
wherein the C₁-C₆ alkylene, C₁-C₆ heteroalkylene, C₂-C₆ alkenylene, C₂-C₆ heteroalkenylene, C₂-C₆ alkynylene, C₃-C₆ heteroalkynylene, arylene and heteroarylene group is independently optionally substituted with at least one selected from the group consisting of C₁-C₆ alkyl, C₁-C₆ haloalkyl, —OH, C₁-C₆ alkoxy, cyano, halo, nitro, —NH₂, —NH(C₁-C₆ alkyl), —N(C₁-C₆ alkyl)(C₁-C₆ alkyl), —C(═O)NH₂, —COOH and —COO(C₁-C₆ alkyl).

13. The method of claim 12, wherein the mixture is allowed to react for a period of about 1 hour to about 2 weeks.

14. The method of claim 12, wherein the mixture is allowed to react at room temperature.

15. The method of claim 12, wherein the mixture is heated to a temperature of about 120° C.

16. The method of claim 12, wherein the proton acceptor is at least one selected from the group consisting of LiOH, NaOH, KOH, CsOH, Mg(OH)₂, Ca(OH)₂, Sr(OH)₂, Ba(OH)₂, Al(OH)₃, Fe(OH)₂, Fe(OH)₃, Cr(OH)₂, Cr(OH)₃, Mn(OH)₂, Mn(OH)₃, Co(OH)₂, Co(OH)₃, Ni(OH)₂, Ni(OH)₃, Cu(OH)₂, CuOH, AuOH, Au(OH)₃, Zn(OH)₂, AgOH, Cd(OH)₂, Cd(OH)₃, ammonia, alkylamines, dialkylamines, trialkylamines, arylamines, diarylamines, triarylamines, alkylarylamines, diakylarylamines and alkyldiarylamines.

17. The method of claim 12, wherein the organic solvent is at least one selected from the group consisting of dimethylformamide, tetrahydrofuran and chloroform.
